(19) United States
(12) Patent Application Publication
(10) Pub. No.: US 2009/0283978 A1
(43) Pub. Date: Nov. 19, 2009

(54) DEVICE FOR TRANSPORTING A TODDLER ACROSS SNOW

(76) Inventor: David Fitzgerald, Hayward, CA (US)

Correspondence Address: Goodwin Procter LLP;Attn: Patent Administrator, 135 Commonwealth Drive, Menlo Park, CA, 94025-1105, US

(21) Appl. No.: 12/464,265

(22) Filed: May 12, 2009

Related U.S. Application Data
(60) Provisional application No. 61/052,786, filed on May 13, 2008.

(51) Int. Cl. B62B 13/16

(52) U.S. Cl. 280/20

(57) ABSTRACT

A collapsible stroller like device is described. The device includes a base portion to permit a child to be pushed or pulled across the snow or other surface.

### RELATED APPLICATION

This application claims priority under 35 U.S.C. §119(e) to U.S. provisional application No. 61/052,786, filed May 13, 2008, the entire contents of which are incorporated herein by reference.

### BACKGROUND OF THE INVENTION

1. Field of the Invention

The present invention generally relates to snow transportation devices, and more particularly to devices for transporting toddlers.

2. Discussion of the Background

It can be difficult to transport children across the snow. Toddlers do not have the skills necessary to learn to ski, and must be held or transported by sled. Sleds can be uncomfortable or dangerous for toddlers, and can only be pulled through the snow.

There is need for a toddler transport device that is both comfortable and safe for the child.

### BRIEF SUMMARY OF THE INVENTION

The present invention overcomes the limitations and problems of the prior art by providing a stroller-like snow transport device for toddlers. This device is referred to herein, without limitation, as a “toddler sled.”

It is one aspect of the present invention to provide a snow transport vehicle for a child. The vehicle includes a flexible portion; a base portion configured to slide on snow or other surfaces, (e.g., a pair of skis, a sled/ski base) and a collapsible frame attached to the flexible portion and the base portion. The frame supports the flexible portion to form a seat. In preferred embodiments, the seat is configured to hold a child, preferably a toddler, in a safe manner. In embodiments, the toddler may be pushed or pulled across snow or other surfaces safely.

In one aspect, the present invention provides a snow transport device for toddlers comprising a flexible portion; a base portion, and a collapsible frame attached to said flexible portion and said base portion, such that said frame supports said flexible portion to form a seat configured to safely hold said toddler, and wherein said base portion is configured to slide on snow or other surface. In some embodiments, the base portion comprises a pair of skis. In other embodiments, the base portion comprises a unitary base. In other embodiments, the frame of said snow transport device supports the flexible portion to form a combined seat and foot strap. In some embodiments, the seat is removable. In embodiments, the flexible portion comprises a pouch.

In some embodiments, the snow transport device comprises a track, wherein at least a portion of said frame or base portion is configured to slide along said track effective to allow the collapse of said snow transport device.

In embodiments, the snow transport vehicle comprises a collapsible frame which may be an inverted U-shape frame. In other embodiments, the collapsible frame is a U-shape frame. In some embodiments, the U-shape frame comprises a pivot, which pivot serves as a foot rest and/or bumper. In embodiments, the collapsible frame is tubular. In embodiments, the collapsible frame comprises a lock. In some embodiments, the lock comprises a first link, a second link, and a latch which connects the first link and the second link.

In embodiments, the collapsible frame of the snow transport device comprises handles.

In embodiments, the snow transport device has a length of between about 10 and about 40 inches. In embodiments, the snow transport device has a width of between about 10 and about 30 inches. In embodiments, the snow transport device has a height of between about 9 and about 20 inches. In embodiments, the snow transport device has a ski height of between about 2 and about 7 inches.

A snow transport device having features of the invention may comprise a seat belt and/or a tow rope.

These features together with the various ancillary provisions and features which will become apparent to those skilled in the art from the following detailed description, are attained by the vehicle of the present invention, preferred embodiments thereof being shown with reference to the accompanying drawings, by way of example only, wherein:

### BRIEF DESCRIPTION OF THE SEVERAL VIEWS OF THE DRAWINGS

FIG. 1 is a front perspective view of a first embodiment of a toddler sled in an open configuration;

FIG. 2 is a side view of the sled of FIG. 1 is a collapsed configuration;

FIG. 3 is a side view of the sled of FIG. 1 in an open configuration;

FIG. 4 is a rear perspective view of the sled of FIG. 1 in an open configuration;

FIG. 5 is a top view of the sled of FIG. 1 in a collapsed configuration;

FIG. 6 is a top perspective view of the sled of FIG. 1 in a collapsed configuration;

FIG. 7 is a front perspective view of a second embodiment toddler sled in an open configuration;

FIG. 8 is a rear perspective view of the sled of FIG. 7 in an open configuration;

FIG. 9 is a side view of the sled of FIG. 7 in an open configuration;

FIG. 10 is a side view of the sled of FIG. 7 in a collapsed configuration;

FIG. 11 is a front perspective view of a third embodiment toddler sled in an open configuration, including an exploded view of various components;

FIG. 12a is a top view of a fourth embodiment toddler sled in an open configuration; FIG. 12b is a side view of a fourth embodiment toddler sled in an open configuration; and FIG. 12c depicts the ski cross-section of a fourth embodiment toddler sled;

FIG. 13 is a front perspective view of a fifth embodiment of a toddler sled in an open configuration; and

FIG. 14. is a front perspective view of a sixth embodiment of a toddler sled in an open configuration.

Reference symbols are used in the Figures to indicate certain components, aspects or features shown therein, with reference symbols common to more than one Figure indicating like components, aspects or features shown therein.

### DETAILED DESCRIPTION OF THE INVENTION

Certain embodiments are presented of a snow-compatible transport device for a toddler. The device includes a seat supported by a base portion, which may be, e.g., a pair of skis or a unitary base configured to slide on snow or on other surfaces. With a toddler seated in such a device, a toddler may be pulled or pushed across the snow or other surfaces.

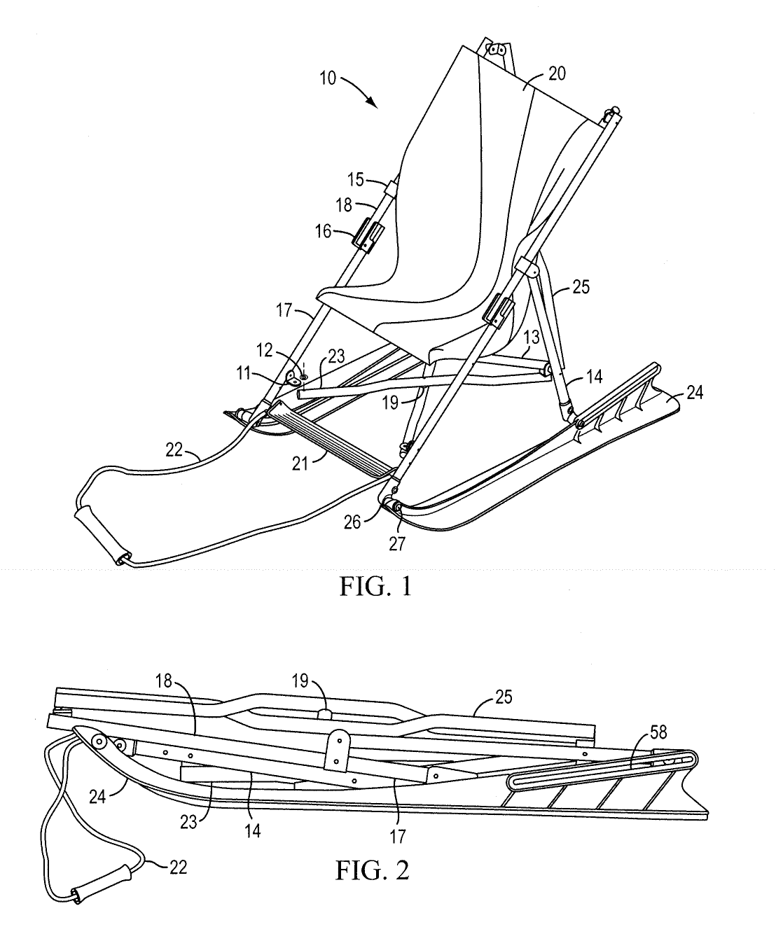

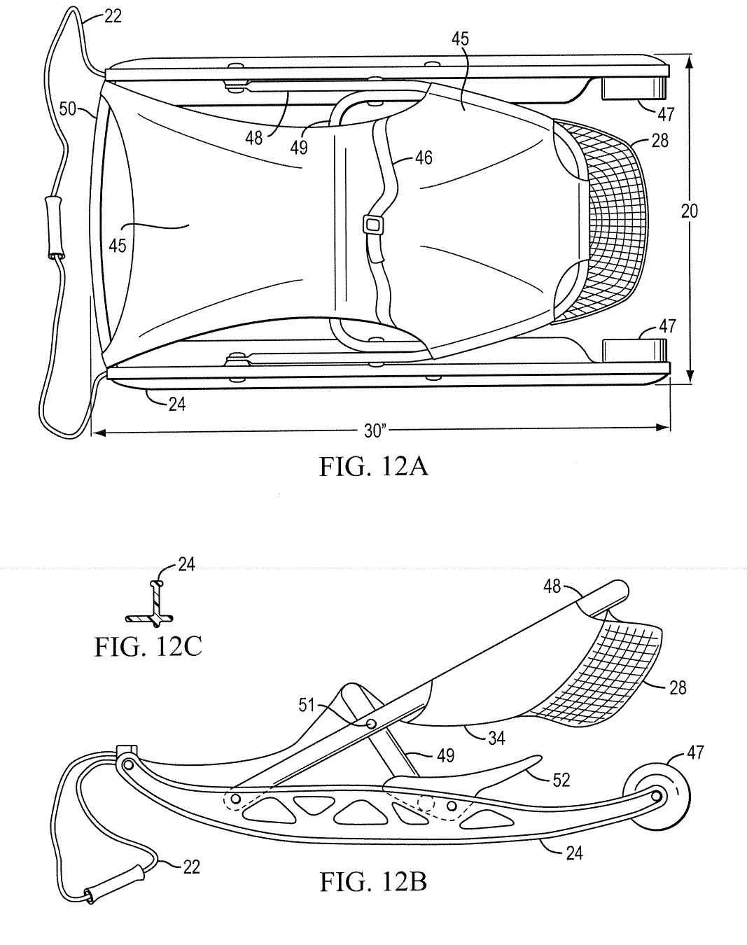

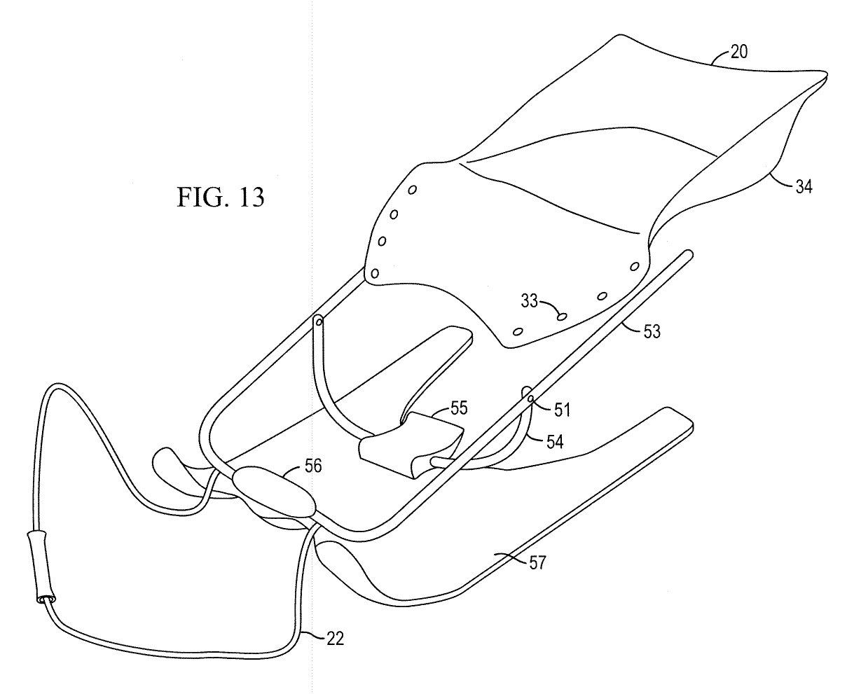

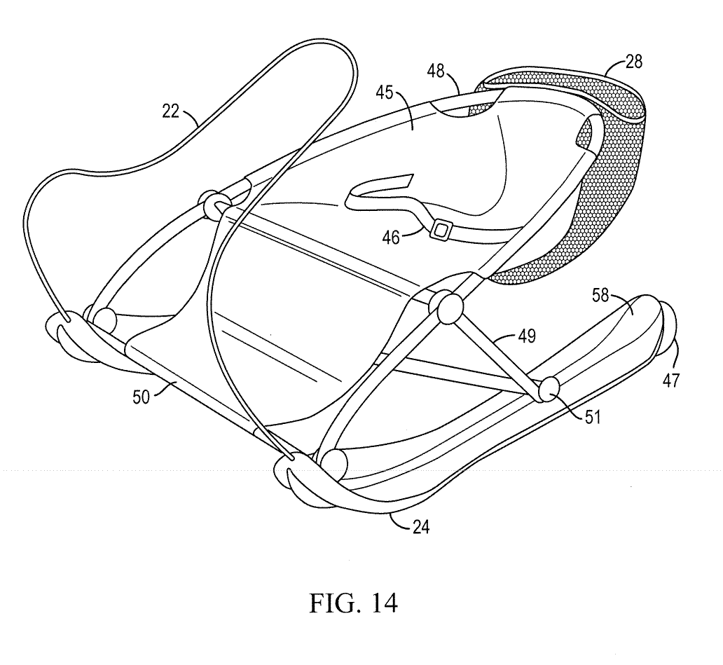

FIG. 1 is a front perspective view of a first embodiment of a toddler sled in an open configuration. FIG. 2 is a side view of the sled of FIG. 1 is a collapsed configuration. In one embodiment, the toddler sled includes a seat formed of a flexible material, such as a cloth or a mesh, a pair of skis, and a frame that supports the seat on the skis. The skis may be, for example, two separate skis, as shown, e.g., in FIG. 1, or can be one unit, forming a sled/ski base as shown, e.g., in FIGS. 11 and 13. In one embodiment, the frame is tubular. The Toddler Sleds of the present invention may also include seat belts, as shown, e.g., in FIGS. 12 and 14, for the child. In the embodiments shown, the frame is collapsible. Thus, in certain embodiments, the frame is similar to those found in collapsible strollers. The number and arrangement of parts to permit a toddler sled to be configured in positions, orientations, and arrangements between those configurations shown in the figures are known in the field.

In one embodiment, the frame is a tubular structure formed from a plurality of components, resulting in a light weight sled. The parts for such a structure are illustrated in FIG. 1 and FIG. 2, which depicts a first embodiment of a toddler sled 10 comprising an unequal leg right angle bracket 11, a washer 12, a seat support 13, a rear leg 14, a pivot connector 15, a 180 pivot support 16, a lower diagonal 17, an upper diagonal 18, a polypropylene stand-off 19, a seat 20 and a pouch 28, a foot strap 21, a tow rope 22, the bottom frame 23, a pair of skis 24, the rear frame 25, a Pivot boss 26, and a Front pivot 27. As shown in FIG. 1, 11 and 23 are shown disassembled to illustrate attachment and it will be understood that in use, 11 and 23 are pivotally attached, e.g., by a pin placed through holes in 11 and 23. In certain embodiments, a seat 20 may be a textile seat, or a seat comprising any other suitable material.

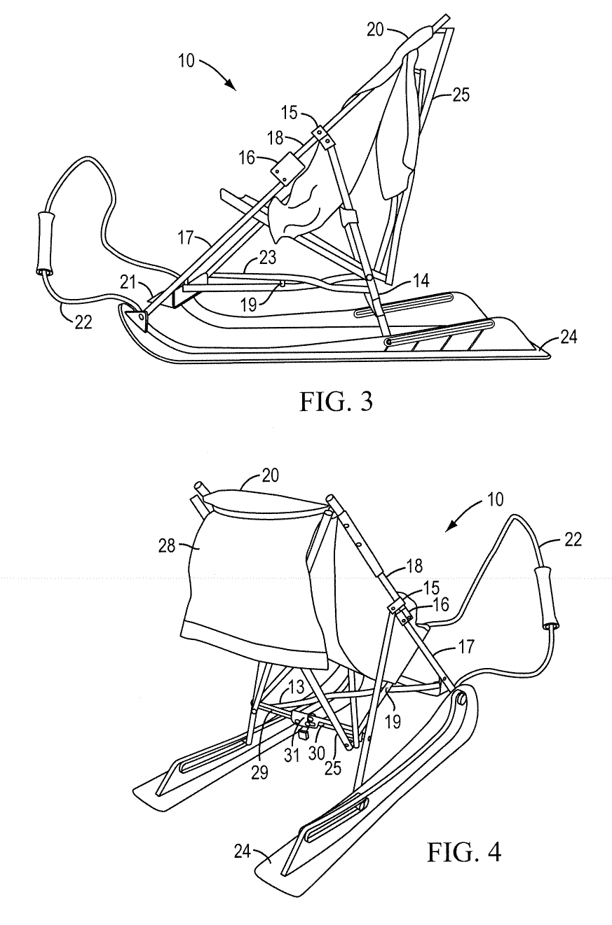

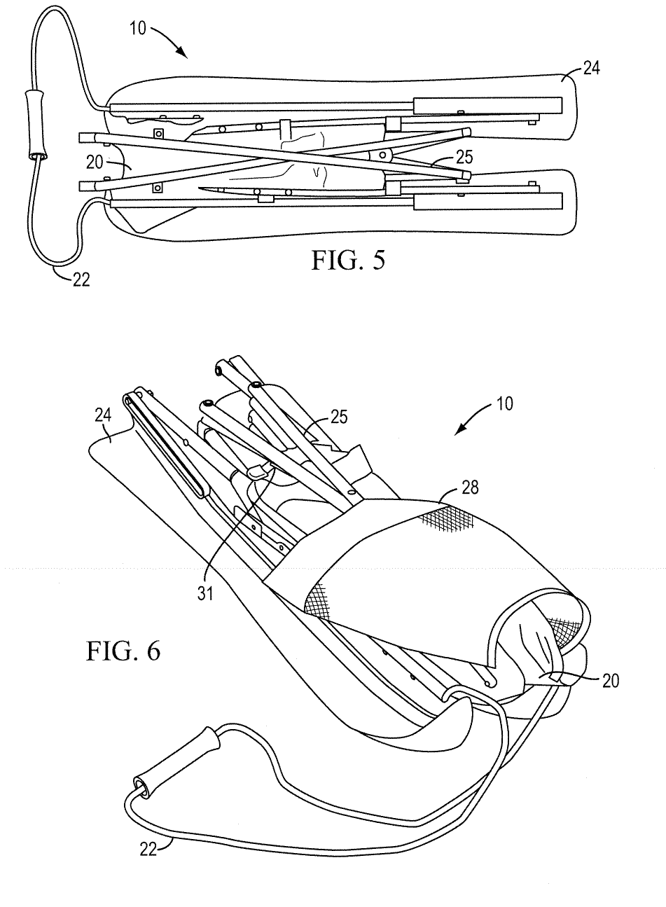

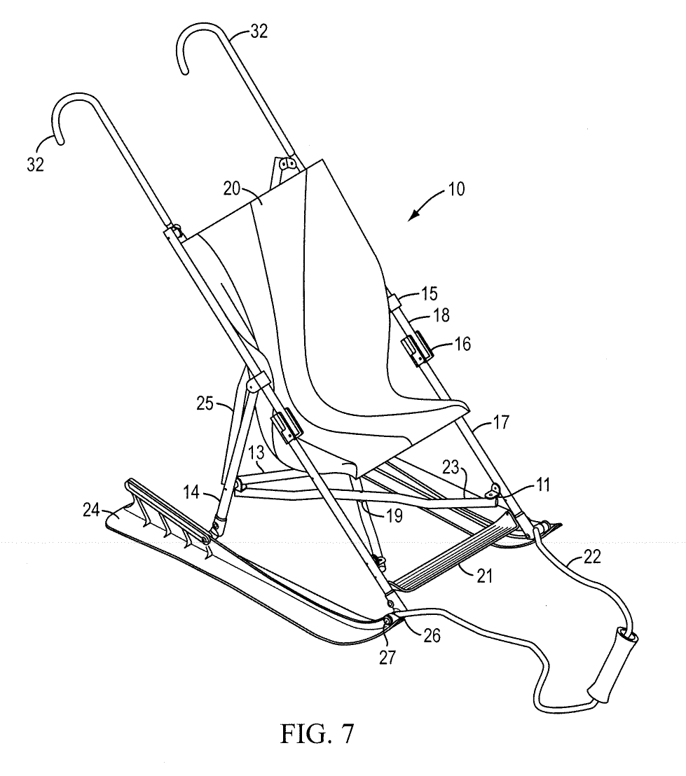

FIGS. 3-6 depict various configurations of the embodiment of FIGS. 1 and 2. FIG. 3 is a side view of the sled in an open configuration; FIG. 4 is a rear perspective view of the sled in an open configuration, showing the pouch 28; FIG. 5 is a top view of the sled in a collapsed configuration; and FIG. 6 is a top perspective view of the sled in a collapsed configuration.

One embodiment for a lock for collapsing the sled is shown in FIG. 4. A rear horizontal support element includes a Link 1 29 rotatably attached to one side of the frame 13, a Link 2 30 rotatably attached to the other side of the frame 13, and a Latch 31 connecting Link 1 29 and Link 2 30.

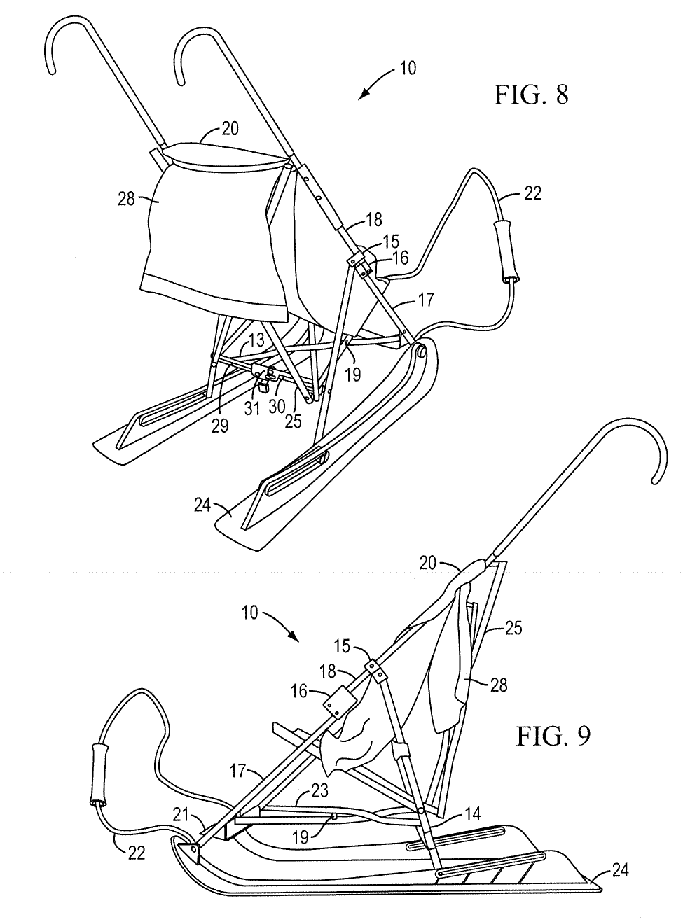

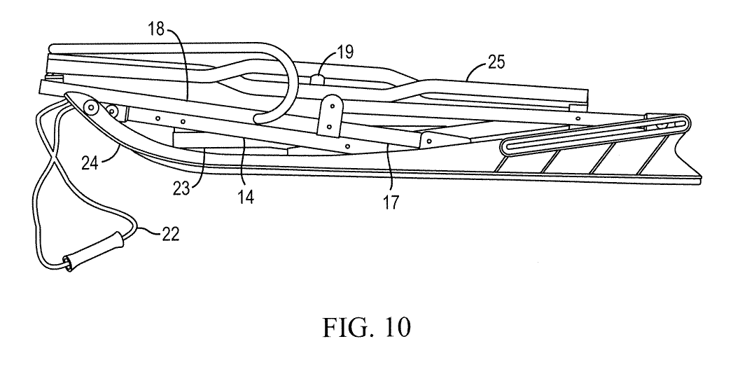

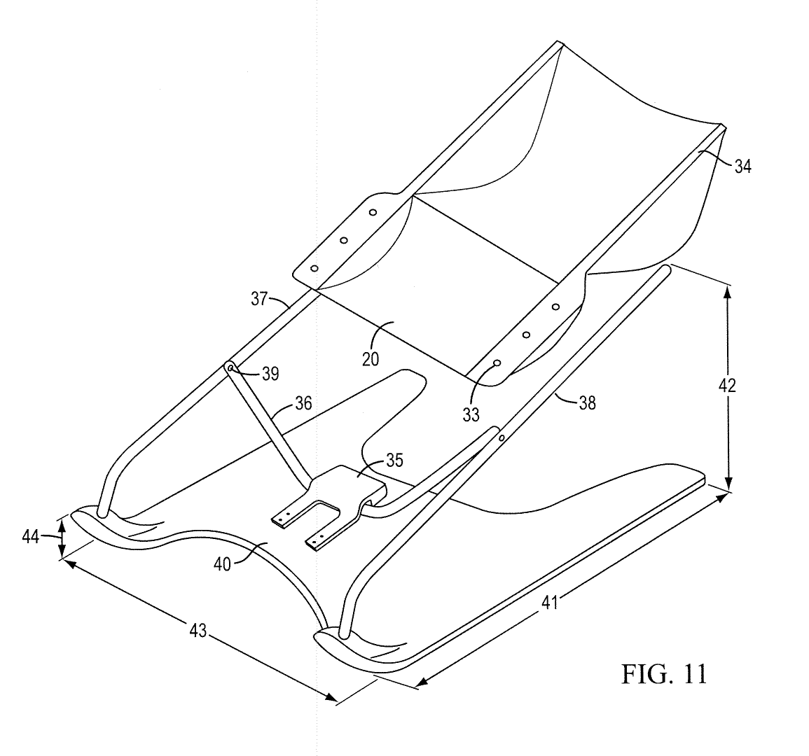

A second embodiment has a pair of handles 32 on the back of the toddler sled that may be used for pushing the sled. This embodiment is shown in the following figures: FIG. 7 is a front perspective view of the second embodiment toddler sled in an open configuration; FIG. 8 is a rear perspective view of the sled in an open configuration; FIG. 9 is a side view of the sled in an open configuration; and FIG. 10 is a side view of the sled in a collapsed configuration. Although the embodiment having handles 32 is shown in FIGS. 7-10 as including a tow rope 22, it will be understood that in embodiments (e.g., an embodiment of a toddler sled 10 having handles 32) a tow rope 22 may not be included, or may be removably attached (e.g., may be attached or may be detached as desired) so that an embodiment of a toddler sled 10 as disclosed herein may be used with or without a tow rope 22 as desired.

A third embodiment of the toddler sled 10, depicted in FIG. 11, has a sled base 40, attached to a left side frame 37 and a right side frame 38, which in certain embodiments is tubular. The toddler sled 10 also includes a removable textile seat 20 having snaps 33 and sleeves 34, which function to attach the textile seat 20 and pouch 28 to side tubes 37 and 38. The textile seat 20 and pouch 28 are supported by a stand 36 which is attached to the side tubes by a pivot 39 and attached to the sled base by a latch 35. In one embodiment, the toddler sled 10 has a length 41 between about 10 and about 40 inches. In a specific embodiment, the length 41 is 29 inches. In one embodiment, the toddler sled 10 has a height 42 between about 9 and about 20 inches. In a specific embodiment the height 42 is 13 inches. In one embodiment, the toddler sled 10 has a width 43 between about 10 and about 30 inches. In a specific embodiment, the width 43 is 21 inches. In one embodiment, the toddler sled 10 has a ski height 44 between about 2 and about 7 inches. In a specific embodiment, In a specific embodiment, the ski height 44 is 4.5 inches.

A fourth embodiment of the toddler sled 10, depicted in FIG. 12, has a combined seat and foot strap 45, having a seatbelt 46, attached to two skis 24 having rear wheels 47, by an inverted U-shaped collapsible frame 48, a stand 49 and having a support cross bar 50. In one embodiment, the toddler sled 10 also includes a latch 52 which provides a means for collapsing the toddler sled. FIG. 12a is a top view of a fourth embodiment toddler sled in an open configuration; FIG. 12b is a side view of a fourth embodiment toddler sled in an open configuration; and FIG. 12c depicts the ski cross-section of a fourth embodiment toddler sled.

A fifth embodiment of the toddler sled 10, depicted in FIG. 13, has a sled base 57, attached to a removable textile seat 20 having snaps 33 and sleeves 34, which function to attach the textile seat 20 and pouch 28 to the U-shaped collapsible frame 53, which in certain embodiments may be tubular. The U-shaped frame 53 is attached to the sled base by a pivot 56 and stand 54. In certain embodiments, the pivot 56 also can serve as a foot rest and/or bumper. In one embodiment, the toddler sled 10 also includes a latch 55 which provides a means for collapsing the toddler sled.

A sixth embodiment of the toddler sled 10, depicted in FIG. 14, has a combined seat and foot strap 45, having a seatbelt 46, attached to two skis 24 having rear wheels 47, by an inverted U-shaped collapsible frame 48, a stand 49 and having a support cross bar 50. In one embodiment, the toddler sled 10 collapses by sliding along a track 58 on the skis 24. A track 58 may be a track 58 as shown, e.g., in FIG. 2, or, e.g., as shown in FIG. 14.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

I claim:

1. A snow transport device for toddlers comprising:
a flexible portion;
a base portion, and
a collapsible frame attached to said flexible portion and said base portion, such that said frame supports said flexible portion to form a seat configured to safely hold said toddler, and wherein said base portion is configured to slide on snow or other surface.

2. The snow transport device of claim 1, wherein the base portion comprises a pair of skis.

3. The snow transport device of claim 1, wherein the base portion comprises a unitary base.

4. The snow transport device of claim 1, wherein the collapsible frame is an inverted U-shape frame.

5. The snow transport device of claim 1, wherein the collapsible frame is a U-shape frame.

6. The snow transport device of claim 5, wherein the U-shape frame comprises a pivot, which pivot serves as a foot rest and/or bumper.

7. The snow transport device of claim 1, wherein the collapsible frame is tubular.

8. The snow transport device of claim 1, comprising a track, wherein at least a portion of said frame or base portion is configured to slide along said track effective to allow the collapse of said snow transport device.

9. The snow transport device of claim 1, wherein the frame supports the flexible portion to form a combined seat and foot strap.

10. The snow transport device of claim 1, wherein the collapsible frame comprises a lock.

11. The snow transport device of claim 10, wherein the lock comprises a first link, a second link, and a latch which connects the first link and the second link.

12. The snow transport device of claim 1, wherein the collapsible frame comprises handles.

13. The snow transport device of claim 1, wherein the seat is removable.

14. The snow transport device of claim 1, said snow transport device having a length, wherein the length is between about 10 and about 40 inches.

15. The snow transport device of claim 1, said snow transport device having a width, wherein the width is between about 10 and about 30 inches.

16. The snow transport device of claim 1, said snow transport device having a height, wherein the height is between about 9 and about 20 inches.

17. The snow transport device of claim 2, said ski having a height, wherein the ski height is between about 2 and about 7 inches.

18. The snow transport device of claim 1, further comprising a seat belt.

19. The snow transport device of claim 1, further comprising a tow rope.

20. The snow transport device of claim 1, wherein the flexible portion comprises a pouch.
